(19) United States
(12) Patent Application Publication
(10) Pub. No.: US 2024/0373984 A1
(43) Pub. Date: Nov. 14, 2024

(54) USE OF HEATING INSTRUMENT FOR SHOES

(71) Applicant: Daniel Kim, Portland, OR (US)

(72) Inventor: Daniel Kim, Portland, OR (US)

(21) Appl. No.: 18/401,490

(22) Filed: Dec. 31, 2023

Related U.S. Application Data
(63) Continuation of application No. 16/978,010, filed on Sep. 3, 2020, now abandoned.

(30) Foreign Application Priority Data
Mar. 5, 2018 (US) 62638673

(51) Int. Cl. A43B 17/00; A43D 86/00

(52) U.S. Cl. CPC A43B 17/00; A43D 86/00

(57) ABSTRACT

The present application discloses a shoe heating apparatus including a base with a heating unit, and a thermally insulative body, wherein the bottom of the base is shaped as bottom of a foot such that it fits with a shoe sole.

### BACKGROUND ART

Many boots and shoes have an upper formed from a flexible sheet material such as imitation leather or real leather, with a base of the upper mounted on a sole molded from a polymer plastic or rubber material. The use of synthetic materials in the manufacture of soles for boots and shoes is already well established, PVC, polyurethane, EVA and thermoplastic rubber have all been used to fulfill this purpose. These synthetic materials have suitable functional properties and are aesthetically pleasing as well as being comfortable. Rubber, however, is particularly sought after because of its durability, its resistance to hydrolysis and bacterial attack and its thermal resistance.

During the production process the upper is typically formed around a forming last in a first manufacturing step and then the sole is injection molded onto a base (i.e. insole) of the upper in a second manufacturing step. The forming last provides a template for the three-dimensional size and shape of the upper. Accordingly, the first step involves mainly shaping and stitching the upper. As there is generally no heating involved in this step the last can be made from a variety of materials, including non-thermally conductive material. Wood and metal have traditionally been used, and more recently plastic. Plastic is particularly preferred in lasts today because it is easy to form into the desired shape and is also relatively inexpensive.

The second manufacturing step in the conventionally practiced production process involves injection molding of the outsole onto the base of the upper. As mentioned above, several synthetic materials have been known to be used for the outsole. Rubber, however, is seen as being particularly attractive and so-called twin density rubber soles are particularly desirable because they provide a tough outsole and a resilient midsole. Twin density rubber soles therefore provide a durable wear surface at the outsole while maintaining cushioned comfort for the wearer with the resilient midsole. Expanded vulcanized rubber in the mid-sole contains cavities or cells (either open or closed) which give the mid-sole its desired level of resilience.

This process requires an intermediate step of removing the upper from the forming last and transferring the upper to the injection molding assembly. This process has the disadvantage that it is very labor intensive and can easily add 25% to the manufacturing cost for a pair of shoes. Not only may this create an unsatisfactory product but it may also delay production while the problem is rectified.

It would therefore be highly desirable to provide a method of integrating the production process steps of creating footwear that would clearly streamline the production process and reduce the production costs.

### BRIEF DESCRIPTION OF THE DRAWINGS

The present invention will become more fully understood from the detailed description given herein below, and the accompanying drawings which are given by way of illustration only, and thus are not limitative of the present invention, and wherein;

FIG. 1 is a schematic sectioned side view of basic shoe heating instrument.

FIG. 2 is a schematic sectioned side view of the forming/heating last.

### DISCLOSURE OF THE INVENTION

In the present application, “a” and “an” are used to refer to both single and a plurality of objects.

As used herein, a “sole” refers to an outsole or midsole that fuses with the upper.

As used herein, a “shoe heating instrument” or “heating instrument” or “instrument” is used to heat the bottom of the shoe upper so that the sole or the upper bottom that has the hot melt adhesive applied on it, will melt and cool and cause a strong bond between the sole and the bottom of the upper. This is achieved by inserting the shoe heating instrument into the opening of the shoe upper and allowing the instrument to settle in whereby the bottom of the instrument is heated. The shoe heating instrument is similar to a shoe last in that at a minimum the bottom of the instrument is shaped so that the bottom of the shoe upper and the sole that contacts the bottom of the shoe upper fit well together within the shape of the bottom of the instrument. In this regard, the heating last can be considered to be a more complicated version of a shoe heating instrument, but the common feature between the heating last and heating instrument is that the base of the heating instrument is required to be particularly shaped to fully receive and fit the sole to the bottom of the upper, and that the base of the instrument can be heated such as by thermal conduction or induction.

Thus, as used herein, whenever “heating instrument” is used, “heating last” is also contemplated within the scope of the terminology in that a pre-templated heating base is used to fuse upper with the sole.

As used herein, a shoe “last” refers to a “forming last” or “heating or heated last”. “Heating last” and “heated last” are used interchangeably in the present application.

As used herein, a “forming last” is used to shape the shoe upper.

As used herein, a “heating or heated last” is used to heat the bottom of the shoe upper so that the sole that has the hot melt adhesive applied on it, will melt and cool and cause a strong bond between a sole and the bottom of the upper. This is achieved by inserting the heating or heated last into the opening of the shoe upper and allowing the last to settle in whereby the bottom of the last is heated. Alternatively, the heating last can serve as a forming last. After the shoe upper is shaped by the forming last, and without removing the last from the upper, a heat plate on the bottom is heated while a hot melt film adhesive applied sole is held in place fitted into close contact with the bottom of the upper. The heat from the heating last melts the adhesive, and a strong bond is formed between the shoe upper and the sole.

On occasion, perhaps an upper is made without necessarily using a forming last, in which case if it is desired to fuse the sole to the upper, the sole can be brought juxtaposed to the bottom of the upper and the heating last or heating instrument can be used to heat the hot melt adhesive placed on the sole to make the shoe.

In one aspect, the present invention is directed to a shoe heating apparatus comprising a base with a heating unit, and a thermally insulative body, wherein bottom of the base is shaped as bottom of a foot such that it fits with a shoe sole. The body may be a shoe last, And the heating unit may be thermally inductive or conducive unit.

In another aspect, the present invention is directed to a method of fusing upper of a shoe to a sole, comprising the steps of:
(i) contacting a pre-formed rubber sole on to the bottom of a pre-formed upper, wherein either or both of the pre-formed rubber sole or the pre-formed upper is covered with heat sensitive adhesive such as hot melt film adhesive on the sides of the pre-formed rubber sole or the pre-formed upper that are desired to be contacted with each other so as to form a permanent bond;
(ii) inserting a heating instrument having a body and a base to the upper;
(iii) heating the base of the instrument, while substantially preventing the heating of parts of the body other than the base, resulting in the melting of the heat-sensitive adhesive; and
(iv) allowing the shoe upper and sole to cool down, whereupon permanent bond is established between them. Steps (i) and (ii) may be reversed. Preferably, non-woven fabric is placed between the sole and upper. The shoe may be an athletic shoe, but all manner of shoes are contemplated by the present invention. The heating instrument may be heating last.

In another aspect, the present invention is directed to a method of fusing upper of a shoe to a sole, comprising the steps of:
making an upper around the shoe last described above, having a body and a base with a heating unit;
contacting a pre-formed rubber sole on to bottom of the upper, wherein either or both of the pre-formed rubber sole or the upper is covered with heat sensitive adhesive such as hot melt film adhesive on the sides of the pre-formed rubber sole or the upper that are desired to be contacted with each other so as to form a permanent bond;
heating the base of the shoe last, while substantially preventing the heating of parts of the body other than the base, resulting in the melting of the heat-sensitive adhesive; and
allowing the shoe upper and sole to cool down, whereupon permanent bond is established between them. Non-woven fabric may be placed between the sole and upper. The shoe may be a boot, athletic shoe, or walking shoe or any other type of shoe that uses a last to make an upper.

In another aspect, the present invention is directed to a method of fusing upper of a shoe to a sole, comprising the steps of:
making an upper around the a forming last;
removing the forming last from the upper;
inserting a heating instrument having a body and a base to the upper described above;
contacting a pre-formed rubber sole on to bottom of the upper, wherein either or both of the pre-formed rubber sole or the upper is covered with heat sensitive adhesive such as hot melt film adhesive on the sides of the pre-formed rubber sole or the upper that are desired to be contacted with each other so as to form a permanent bond;
heating the base of the shoe last, while substantially preventing the heating of parts of the body other than the base, resulting in the melting of the heat-sensitive adhesive; and
allowing the shoe upper and sole to cool down, whereupon permanent bond is established between them. Non-woven fabric may be placed between the sole and upper. The shoe may be a boot, athletic shoe, or walking shoe or any other type of shoe that uses a last to make an upper.

In another aspect, the present invention directed to shoes that are made from the processes described above.

According to an aspect of the present invention, there is provided a method of making an item of footwear such as a shoe such as athletic footwear or a boot, comprising the steps of:
forming an upper for the item of footwear on a forming last, the forming last including a body having the general shape of a foot around which the upper of the footwear item is to be formed, the body having a base corresponding in shape to a sole of the foot;
bonding a pre-formed rubber sole on to the bottom of the pre-formed upper, wherein either or both of the pre-formed rubber sole or the pre-formed upper is applied with heat sensitive adhesive such as hot melt film adhesive on the sides of the pre-formed rubber sole or the pre-formed upper that are desired to be contacted with each other so as to form a permanent bond; and
heating the bottom of the formed upper while the upper is still mounted on the forming last, wherein the step of heating the forming last includes heating the base of the last body, while substantially preventing the heating of pails of the body other than the base, resulting in the melting of the heat-sensitive adhesive, and whereupon cooling the shoe upper and sole, permanent bond is established between the sole and the upper.

In the above process, the heating last may be also used as a forming last for the upper. Or, the heated last and forming last may be different or separately used. In certain situations, for instance in the case of certain types of athletic footwear that do not require a forming last to shape the upper, only the heated last or a heating instrument may be needed to fuse the sole to the upper. The instrument or last may be inserted into the pre-formed upper and the base of the last or instrument may be heated.

As mentioned above, the inventive method is directed to fusing a pre-formed sole to an upper using a heated last or a heating instrument in the manner as described above. That is, the instrument is heated at the base portion as it comes into contact with the bottom portion of the pre-formed upper as the sole is fitted to the bottom of the upper, wherein the heat sensitive adhesive is layered between bottom of the upper and the sole.

A Tricot machine may be used in which a sole is positioned underneath the bottom of the upper, a heating instrument is inserted into the upper and is pressed down on the bottom of the upper where the bottom of the upper is in contact with the sole such that when the instrument is heated, a bond between the shoe upper and the sole is formed through the melting of a hot melt adhesive film juxtaposed between the bottom of the upper and the sole.

Preferably, non-woven textile that is made of entangled thin layers of fiber can be laminated as a cheap carrier to bind the sole or outsole to the upper. The melting temperature of hot-melt film and the various types of polymers used can be determined using known tables.

Conventionally, in certain situations, the last has been used to heat certain portions of a shoe upper. For example, the toe area could be heated to cause a certain shape, or the heel area could be heated to effectuate a certain shape as to the upper. However, the heated last had not been conventionally used to fuse the upper to the sole in the manner as in the present invention.

While conventional thermal conduction heating mechanism may be used, induction heat can be used as another mechanism of heating the instrument. This is exemplified in U.S. Pat. No. 8,959,690, which is incorporated by reference herein as to the disclosure of induction mechanism of heating a last.

In a preferred form of the present invention the method includes the step of heating the forming last before and/or during the step of bonding the rubber sole onto the formed upper. The forming last typically includes a body mimicking the general shape of a foot, around which body the upper of the item of footwear is formed. Furthermore, the body typically has a base corresponding in shape as a template to a sole of the foot. In a preferred form of the invention, the step of heating the forming last includes heating the base of the last body.

It is to be appreciated that the present invention also extends to an item of footwear made in accordance with the method described above.

According to another aspect of the present invention there is provided an apparatus for making an item of footwear such as a shoe or a boot, including: a forming last comprising a body as a template for forming general shape of a foot around which an upper is to be formed, the body of the last having a base corresponding to a sole of the foot comprising a heating unit, and the rest of the body is made of insulating material so as to isolate the heat to the base portion of the last.

Thus, with the apparatus of the invention it is not necessary to remove the shoe or boot upper from the last before the rubber sole is bonded onto the upper. Rather, the apparatus comprises heating element for supplying necessary heat to the forming last or instrument to efficaciously and quickly bind the rubber sole. Optionally, the forming last and the heated last may be different, in which case the upper would be removed from the forming last, and then a heating instrument, which may include a heating last, may be placed inside the shoe upper and the based heated.

In a preferred embodiment of the invention, the heating base of the last body is located within the last. Preferably the base of the last body includes a metallic portion such as one or more metal plate member defining an outer surface of the base to which heat is transmissible from the heating unit. The heating unit may include one or more electrically activated heating element located inside the last adjacent an inner side of the plate member(s).

According to a further aspect of the present invention, there is provided a last for making an item of footwear such as a shoe or a boot, including a body having a template for the general shape of a foot around which an upper of the item of footwear is to be formed, the body having a base corresponding to a sole of the foot shape and the last further including a heating unit at the base of the last body, and insulating material to prevent heating parts of the body other than the base area.

In a preferred embodiment of the invention the base of the last body is located within the last and is preferably in the form of one or more electric heating element and may be built in to the body of the last or may be plate or plates screwed into the last. The base of the last body may include a metallic portion such as a plate member to which heat is transmissible from the heating unit. At least one electrically activated heating element may be located inside the last adjacent an inner surface of the plate member(s). The plate members desirably extend across the base of the last body.

In a preferred embodiment of the invention the last body includes a recess or cavity for receiving and housing one or more electrically activated heating element adjacent to the plate member(s). The body of the last is preferably formed predominantly from a plastic such as polyethylene. The plate member is preferably formed of a material having good thermal conductivity, e.g., a metal such as aluminium or steel.

The thermal insulation material serves to insulate parts of the body other than the base, such as the non-metallic parts of the body (in the case of a plastic body, for example) from heat generated by the heating element(s).

Furthermore, in a preferred embodiment of the invention the last body may comprise two distinct portions; namely, a heel portion and a toe portion. The heel portion and the toe portion are separable from one another to facilitate removal of an item of footwear from the last after the sole has been molded.

In one aspect, it is contemplated that the heating unit or heating member may not need to be a last at all, and may be in the form of a basic heating instrument. An intent of the present invention is fusing of the sole to the bottom of the upper. In this regard, any heating unit may be used, without necessarily having the body of a last. For example, considering a basic heating instrument, a rod that is attached to a heating plate may be inserted into the upper thereby heating the bottom of the upper, and fusing to the sole by melting of the hot melt adhesive juxtaposed thereby.

The above and further features and advantages of the present invention will be more fully appreciated from the following detailed description of preferred embodiments of the invention with reference to the accompanying drawings.

### DETAILED DESCRIPTION OF PREFERRED EMBODIMENTS OF THE INVENTION

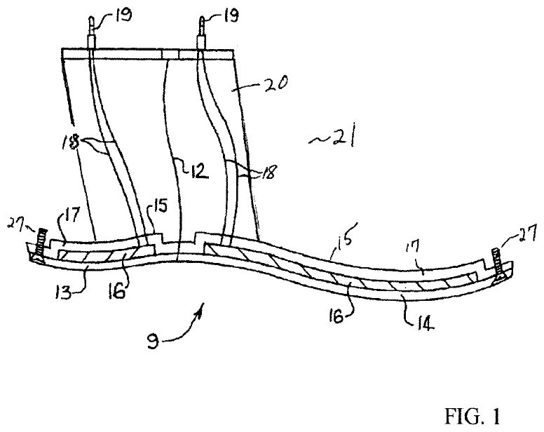

With reference to FIG. 1 of the drawings, each heating instrument (21) includes a holder (20). The holder (20) is formed of a thermal insulator predominantly of polyethylene since this material is relatively inexpensive and can be readily shaped to a specific design. The heating instrument (21) has a base (9), which corresponds to a sole of the foot shape that the heating instrument (21) is designed to be a template.

The base (9) of the heating instrument includes plate members (13, 14), which extend over the base in each of the heel and toe portions (10, 11) of the heating instrument, respectively. The plate members (13, 14) are preferably formed from aluminum, which has good thermal conductivity properties. Other metals, however, may be equally suitable. The plate members (13, 14) present the outer surface at the base of the heating instrument and may be attached to the heating instrument by any suitable fastening, such as screws (27).

The heating instrument also includes a recess (15) for receiving and housing an electrically activated heating element (16) adjacent an inner surface of each of the heel and toe portion base plate members (13, 14). The heating elements (16) are in face-to-face contact with the plate members over a substantial proportion of the surface area of those plate members thereby providing direct and effective heat conduction in a substantially uniform manner over the plate members. The recess (15) also includes insulation material (17) provided on the side of the electric heating elements opposite the base plate members (13, 14) to thermally shield the polyethylene parts of the heel and toe portions (10, 11) from the heat generated by the heating elements. During the bonding of the rubber sole the base plates (13, 14) of the forming are heated in the range of about 100 degrees C. to 120 degrees C., and the heating elements (16) themselves achieve temperatures even higher. The non-metallic parts of the body must therefore be insulated to prevent their undesirable deformation.

Each of the electric heating elements (16) is electrically connected to an electric power supply. Electric wires or leads (18) extend from each of the elements (16) to terminals (19) at a top surface of the heating instrument (21). These terminals (19) are adapted to operate in a male-female bayonet type coupling for connection to the power supply (not shown). Each heating instrument (21) also includes a thermostat (not shown) to monitor and regulate heating of the plate members (13, 14).

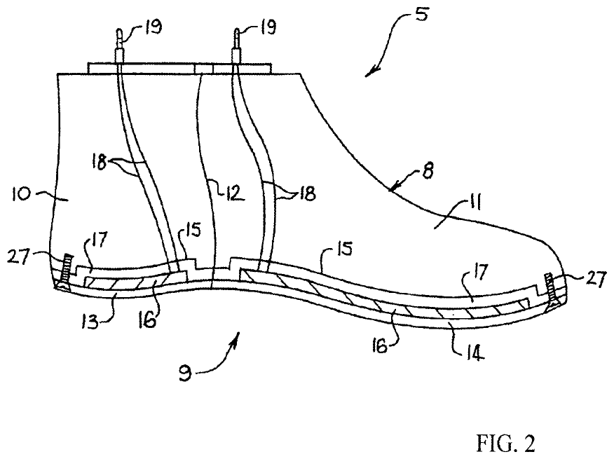

With reference to FIG. 2 of the drawings, each last (5) includes a body (8), which mimics or has the general shape of a foot and provides a template for the shape and size of a particular style shoe. The body (8) of each forming last is formed predominantly of polyethylene since this material is relatively inexpensive and can be readily shaped to a specific last design. The last body (8) has a base (9) which corresponds to a sole of the foot shape that the last body is designed to mimic.

The base (9) of the last body includes plate members (13, 14), which extend over the base in each of the heel and toe portions (10, 11) of the last body, respectively. The plate members (13, 14) are preferably formed from aluminium, which has good thermal conductivity properties. Other metals, however, may be equally suitable. The plate members (13, 14) present the outer surface at the base of the last and may be attached to the last body by any suitable fastening, such as screws (27).

The last body (8) also includes a recess (15) for receiving and housing an electrically activated heating element (16) adjacent an inner surface of each of the heel and toe portion base plate members (13, 14). The heating elements (16) are in face-to-face contact with the plate members over a substantial proportion of the surface area of those plate members thereby providing direct and effective heat conduction in a substantially uniform manner over the plate members. The recess (15) also includes insulation material (17) provided on the side of the electric heating elements opposite the base plate members (13, 14) to thermally shield the polyethylene parts of the heel and toe portions (10, 11) from the heat generated by the heating elements. During the bonding of the rubber sole the base plates (13, 14) of the forming last are heated in the range of about 100 degrees C. to 120 degrees C., and the heating elements (16) themselves achieve temperatures even higher. The non-metallic parts of the last body must therefore be insulated to prevent their undesirable deformation.

Each of the electric heating elements (16) is electrically connected to an electric power supply, Electric wires or leads (18) extend from each of the elements (16) to terminals (19) at a top surface of the last (5). These terminals (19) are adapted to operate in a male-female bayonet type coupling for connection to the power supply (not shown). Each last (5) also includes a thermostat (not shown) to monitor and regulate heating of the plate members (13, 14).

The present invention is not to be limited in scope by the specific embodiments described herein. Indeed, various modifications of the invention in addition to those described herein will become apparent to those skilled in the art from the foregoing description and accompanying figures. Such modifications are intended to fall within the scope of the appended claims. The following examples are offered by way of illustration of the present invention, and not by way of limitation.

Those skilled in the art will recognize, or be able to ascertain using no more than routine experimentation, many equivalents to the specific embodiments of the invention specifically described herein. Such equivalents are intended to be encompassed in the scope of the claims.

What is claimed is:

1. A shoe heating apparatus comprising a base with a heating unit, and a thermally insulative body, wherein bottom of the base is shaped as bottom of a foot such that it fits with a shoe sole.

2. The apparatus of claim 1, wherein the body is a shoe last.

3. The apparatus of claim 1, wherein the heating unit is thermally inductive unit.

4. The apparatus of claim 1, wherein the heating unit is thermally conductive unit.

5. A method of fusing upper of a shoe to a sole, comprising the steps of:
contacting a pre-formed rubber sole on to the bottom of a pre-formed upper, wherein either or both of the pre-formed rubber sole or the pre-formed upper is covered with heat sensitive adhesive such as hot melt film adhesive on the sides of the pre-formed rubber sole or the pre-formed tipper that are desired to be contacted with each other so as to form a permanent bond;
inserting a heating instrument having a body and a base to the upper;
heating the base of the instrument, while substantially preventing the heating of parts of the body other than the base, resulting in the melting of the heat-sensitive adhesive; and
allowing the shoe upper and sole to cool down, whereupon permanent bond is established between them.

6. The method of claim 5, wherein non-woven fabric is placed between the sole and upper.

7. The method of claim 5, wherein the shoe is an athletic shoe.

8. The method of claim 5, wherein the heating instrument is heating last.

9. A method of fusing upper of a shoe to a sole, comprising the steps of:
making an upper around the shoe last of claim 2, having a body and a base with a heating unit;
contacting a pre-formed rubber sole on to bottom of the upper, wherein either or both of the pre-formed rubber sole or the upper is covered with heat sensitive adhesive such as hot melt film adhesive on the sides of the pre-formed rubber sole or the tipper that are desired to be contacted with each other so as to form a permanent bond;
heating the base of the shoe last, while substantially preventing the heating of parts of the body other than the base, resulting in the melting of the heat-sensitive adhesive; and
allowing the shoe upper and sole to cool down, whereupon permanent bond is established between them.

10. The method of claim 9, wherein non-woven fabric is placed between the sole and upper.

11. The method of claim 9, wherein the shoe is a boot, athletic shoe, or walking shoe.

12. A method of fusing upper of a shoe to a sole, comprising the steps of:
making an upper around the a forming last;
removing the forming last from the upper;
inserting a heating instrument having a body and a base to the upper of claim 1;
contacting a pre-formed rubber sole on to bottom of the upper, wherein either or both of the pre-formed rubber sole or the upper is covered with heat sensitive adhesive such as hot melt film adhesive on the sides of the pre-formed rubber sole or the upper that are desired to be contacted with each other so as to form a permanent bond;
heating the base of the shoe last, while substantially preventing the heating of parts of the body other than the base, resulting in the melting of the heat-sensitive adhesive; and
allowing the shoe upper and sole to cool down, whereupon permanent bond is established between them.

13. The method of claim 12, non-woven fabric is placed between the sole and upper.

14. The method of claim 12, wherein the shoe is a boot, athletic shoe, or walking shoe.

15. A shoe made using the method of claim 5.

16. A shoe made using the method of claim 9.

17. A shoe made using the method of claim 12.

18. A complex comprising the apparatus of claim 1 in association with a shoe upper and sole.
